(19) United States
(12) Patent Application Publication
(10) Pub. No.: US 2022/0329920 A1
(43) Pub. Date: Oct. 13, 2022

(54) METHOD, APPARATUS AND SYSTEM FOR PROCESSING VIDEO

(71) Applicant: BEIJING DAJIA INTERNET INFORMATION TECHNOLOGY CO., LTD., Beijing (CN)

(72) Inventor: Bingyang Xiong, Beijing (CN)

(73) Assignee: BEIJING DAJIA INTERNET INFORMATION TECHNOLOGY CO., LTD., Beijing (CN)

(21) Appl. No.: 17/648,341

(22) Filed: Jan. 19, 2022

(30) Foreign Application Priority Data
Apr. 9, 2021 (CN) 202110383888.1

(51) Int. Cl. H04N 21/845; H04N 21/478; H04N 21/4782; H04N 21/84

(52) U.S. Cl. CPC H04N 21/8455; H04N 21/4781; H04N 21/4782; H04N 21/84

(57) ABSTRACT

A method for processing a video includes: receiving a first request sent by a first terminal, in which the first request is configured to request to play a video; and sending target information to the first terminal based on the first request, in which the target information is configured to indicate that the video has already been associated with a game, the target information includes an entry identifier, and the entry identifier is configured to trigger the first terminal to enter the game associated with the video.

### CROSS REFERENCE TO RELATED APPLICATIONS

This application is based on and claim priority to Chinese Patent Application No. 202110383888.1, filed on Apr. 9, 2021, the content of which is incorporated herein by reference in its entirety.

### TECHNICAL FIELD

The disclosure relates to the field of short video, and more particularly to a method, an apparatus and a system for processing a video.

### BACKGROUND

At present, the short video industry is gradually rising, and the scale of short video users is also growing. The short video is second only to the instant messaging, i.e., it has become the second largest network application. At the same time, the web games technology are gradually maturing.

### SUMMARY

According to a first aspect of the disclosure, a method for processing a video is performed by a server and includes: receiving a first request sent by a first terminal, in which the first request is configured to request to play a video; and sending target information to the first terminal based on the first request, in which the target information is configured to indicate that the video has already been associated with a game, the target information includes an entry identifier, and the entry identifier is configured to trigger the first terminal to enter the game associated with the video.

According to a second aspect of the disclosure, a method for processing a video includes: a method for processing a video is performed by a second terminal and includes: sending a second request to a server, in which the second request is configured to instruct the server to associate a video with a game; and receiving target information sent by the server, in which the target information is configured to indicate that the video has already been associated with a game, the target information comprises an entry identifier, and the entry identifier is configured to trigger the first terminal to enter the game associated with the video.

According to a third aspect of the disclosure, an electronic device includes a processor and a memory for storing instructions executable by the processor. The processor is configured to: receive a first request sent by a first terminal, in which the first request is configured to request to play a video; and send target information to the first terminal based on the first request, in which the target information is configured to indicate that the video has already been associated with a game, the target information comprises an entry identifier, and the entry identifier is configured to trigger the first terminal to enter the game associated with the video.

It should be understood that the above general description and the following detailed description are only exemplary and explanatory, without any limitations to the disclosure.

### BRIEF DESCRIPTION OF THE DRAWINGS

The drawings herein are incorporated into the specification and constitute a part of the specification, show embodiments in accordance with the disclosure, and are used to explain the principle of the disclosure together with the specification, which do not constitute an improper limitation to the disclosure.

FIG. 1 is an architecture diagram illustrating an implementation environment according to some embodiments.

FIG. 2 is a flowchart illustrating a method for processing a video according to some embodiments.

FIG. 3 is a flowchart illustrating a method for processing a video according to another exemplary embodiment.

FIG. 4 is a flowchart illustrating a method for processing a video according to yet another exemplary embodiment.

FIG. 5 is a flowchart illustrating a method for processing a video according to yet another exemplary embodiment.

FIG. 6 is a block diagram illustrating an apparatus for processing a video according to some embodiments.

FIG. 7 is a block diagram illustrating an apparatus for processing a video according to another exemplary embodiment.

FIG. 8 is a block diagram illustrating an apparatus for processing a video according to yet another exemplary embodiment.

FIG. 9 to FIG. 11 illustrates system flowcharts work according to an embodiment of the disclosure, respectively.

The reference numbers are illustrates as follows:

01: electronic device 02: server; 03: short video terminal 04: server 05: game platform 06: first terminal.

### DETAILED DESCRIPTION

In order to make those skilled in the art better understand the technical solutions of the disclosure, the technical solutions in the embodiments of the disclosure will be clearly and thoroughly described below with reference to the accompanying drawings.

It should be noted that the terms such as “first” and “second” in the specification, claims and the above-mentioned drawings of the disclosure are used to distinguish similar objects, and not necessarily used to describe a specific sequence or precedence order. It should be understood that the data used in this way may be interchanged under appropriate circumstances so that the embodiments of the disclosure described herein may be implemented in an order other than those illustrated or described herein. The implementations described in embodiments below do not represent all implementations consistent with the disclosure. Rather, they are merely examples of apparatuses and methods consistent with some aspects of the disclosure as detailed in the appended claims.

In the related art, a game portal can be presented in a web page, so that the users can enter and start the game through the game portal in browsing the web page. In this way, there is no need to download an application and there is no problem of insufficient machine configuration. It is extremely convenient to close and switch the game. However, a scheme where the users can enter the game from the short video has not been found.

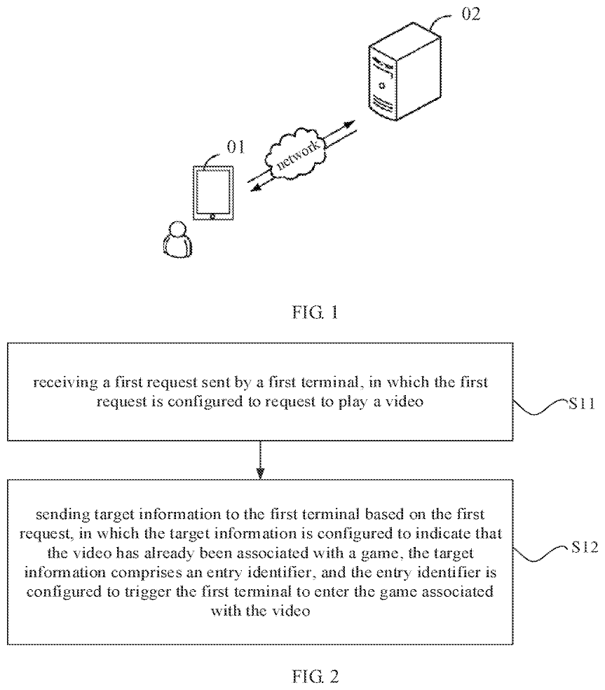

FIG. 1 is an architecture diagram illustrating an implementation environment shown according to some embodiments. As shown in FIG. 1, the following method for processing a video can be applied to an implementation environment that includes an electronic device 01 and a server 02. The electronic device 01 and the server 02 can be interconnected and communicated through a network.

The electronic device 01 includes a second terminal and a first terminal. The electronic device 01 may be any electronic product that can interact with the users through one or more ways such as a keyboard, a touch pad, a touch screen, a remote controller, a voice interaction or handwriting device, for example, a mobile phone, a tablet computer, a handheld computer, a personal computer (PC), a wearable device, a smart TV, etc..

The server 02 can be a server, a server cluster composed of multiple servers, or a cloud computing service center. The server 02 may include a processor, a memory, a network interface, and the like.

Those skilled in the art should understand that the above electronic devices and servers are only examples, and if other existing or possible electronic devices/servers in the future are applicable to the disclosure, they should also be included within the protection scope of the disclosure, which are hereby incorporated by reference.

Based on this, some embodiments of the disclosure provide a method for processing a video, an apparatus for processing a video and a system for processing a video.

The execution subject according to the embodiment of the disclosure can be the above electronic device or server, or functional modules and/or functional entities in the electronic device or server that can perform the method for processing a video. Specifically, it can be determined according to the actual use requirements, and is not limited in the embodiment of the disclosure. Hereafter, taking the execution subject being the server as an example, the method according to the embodiment of the disclosure is exemplarily described.

FIG. 2 is a flowchart illustrating a method for processing a video according to some embodiments. As shown in FIG. 2, the method for processing a video can be used in the server, which includes the following steps S11˜S12.

At S11, a first request sent by the first terminal is received, in which the first request is configured to request to play a video.

At S12, target information is sent to the first terminal based on the first request. The target information is configured to indicate that the video has already been associated with a game and includes an entry identifier configured to trigger the first terminal to enter the game associated with the video.

With the method for processing a video in the disclosure, the first request sent by the first terminal is first received, in which the first request is configured to request to play a video; Then, the target information is sent to the first terminal based on the first request, in which the target information is configured to indicate that the video has already been associated with the game and includes the entry identifier configured to trigger the first terminal to enter the game associated with the video . In the above method, in response to the first request for requesting to play the video sent by the first terminal, the target information with the entry identifier is sent to the first terminal, so that the entry identifier can be displayed synchronously during playing the video on the display interface of the first terminal, in which the entry identifier can trigger the first terminal to enter the game. Therefore, this method ensures a good carrying capacity of video content and can realize entering the game interface from the video playing interface, which thus better solves the problem that the game cannot be entered from the short video in the related art.

In some embodiments, the first terminal is a video playing terminal.

In some embodiments, the video may be a short video. Alternatively, the video can also be other videos in the related art.

According to some embodiments of the disclosure, before sending the target information to the first terminal based on the first request, the method further includes establishing an association between the video and the game and generating the target information. The above method can easily and quickly determine the game associated with the video by establishing the association between the video and the game and generating the above target information.

According to some embodiments of the disclosure, establishing the association between the video and the game and generating the target information includes: receiving a second request sent by the second terminal, in which the second request is configured to request to associate the video with the game; and in response to the second request, establishing the association between the video and the game and generating the target information. By establishing the association between the video and the game and generating the target information in response to receiving the second request, in which the second request is configured to request to associate the video with the game, the users may be caused to determine the game associated with the video according to the actual situation, so as to ensure that the method can be more flexible to meet the needs of different users.

In some embodiments, the second terminal is the video production terminal, that is, the user terminal producing the video.

In some embodiments, the second terminal is the same as the first terminal.

According to some embodiments of the disclosure, before receiving second request sent by the second terminal, the method includes: receiving a third request sent by the second terminal, in which the third request is configured to request a game association function for the video; sending game information to the second terminal and displaying the game information on a display interface of the second terminal, in which the game information includes relevant information of at least one game, the relevant information includes a game address, a game name and a brief game introduction, at least one game includes the game, and the second request is generated in response to a selection operation on the game information. In this way, it is ensured that the users can intuitively view the game information, facilitate the users to browse the game information and determine the game associated with the video according to their needs, which further ensures that the method can be more flexible to meet the needs of different users.

In some embodiments, receiving the third request can also be omitted in the above method, i.e., the game information is directly sent to the second terminal before receiving the second request sent by the second terminal.

In order to further facilitate browsing and selecting the game information by the users, in some embodiments, the game information is displayed in a form of a list on the display interface of the second terminal.

In some embodiments of the disclosure, after receiving the third request sent by the second terminal and before sending the game information to the second terminal, the method further includes: sending a fourth request to a game platform based on the third request, in which the fourth request is configured to request to associate the video with the game platform; and receiving the game information sent by the game platform. In this way, it is ensured that the game information associated with the video can be obtained more simply and quickly.

According to some embodiments of the disclosure, the game information also includes at least one selection identifier corresponding to the at least one game one by one. That is, the selection identifiers correspond to multiple pieces of relevant information of the game one by one in position. For example, when multiple pieces of relevant information are arranged in rows, the selection identifier may be in the same line as the corresponding piece of relevant information, and the selection identifier may be in front of or behind the corresponding piece of relevant information; when multiple pieces of relevant information are arranged in columns, the selection identifiers may be in the same column as the corresponding piece of relevant information, and the selection identifier can be located above or below the corresponding piece of relevant information. The position relationship between the selection identifier and the corresponding piece of relevant information can also be other position relationship. The second request is generated in response to the selection operation on the selection identifier corresponding to the game. In this way, the user can intuitively know to select the above selection identifier, so that the above game corresponding to the above selection identifier is then selected, which further facilitates operations of the user.

In some embodiments, the above selection operation can be an operation such as clicking, sliding, double clicking, long pressing, etc., and it can also be a combination of other suitable operations.

The game information may not include a selection identifier. In this case, the users can select a game associated with the video through an operation on relevant information of the game. The operation may include one or more operations of clicking, sliding, double clicking and long pressing. The operation can also include other appropriate operation or a combination of operations.

In some embodiments, a third request is generated in response to a second operation on a setting page of the second terminal. In this way, operations of the user are further facilitated, so that the third request can be generated and sent more conveniently and quickly.

In order to further facilitate operations of the user, in some embodiments of the disclosure, the setting page includes a start game identifier, and the third request is generated in response to the second operation on the start game identifier. In this way, the user can intuitively know that the game can be started through the second operation on the start game identifier, which is further convenient for the user to operate.

In some embodiments, the second operation can be an operation such as clicking, sliding, double clicking, long pressing, etc., and it can also be other suitable operation or a combination of operations.

In some embodiments, the information also includes a game ID, a game cover and a user who is playing the game. Through the game ID, the game cover and the user who is playing the above game in the information, it is further ensured that the user can have a more intuitive understanding of the game.

According to some embodiments of the disclosure, the information also includes video information, and the video information includes at least one of an author account of the video, an author name of the video and a subject of the video. The information of the video can also include other information of the video, which can be set by those skilled in the art according to actual needs.

In some embodiments, after entering the game in response to the second operation on the start game identifier, the method may include generating a fifth request in response to a third operation on the first terminal, in which the fifth request is configured to request to start the game. The game platform receives the fifth request and sends information of agreeing to start to the first terminal. Based on the information of agreeing to start, the first terminal displays a start interface of the game.

After entering the game in response to the second operation on the start game identifier, the method may also directly display the start interface of the game.

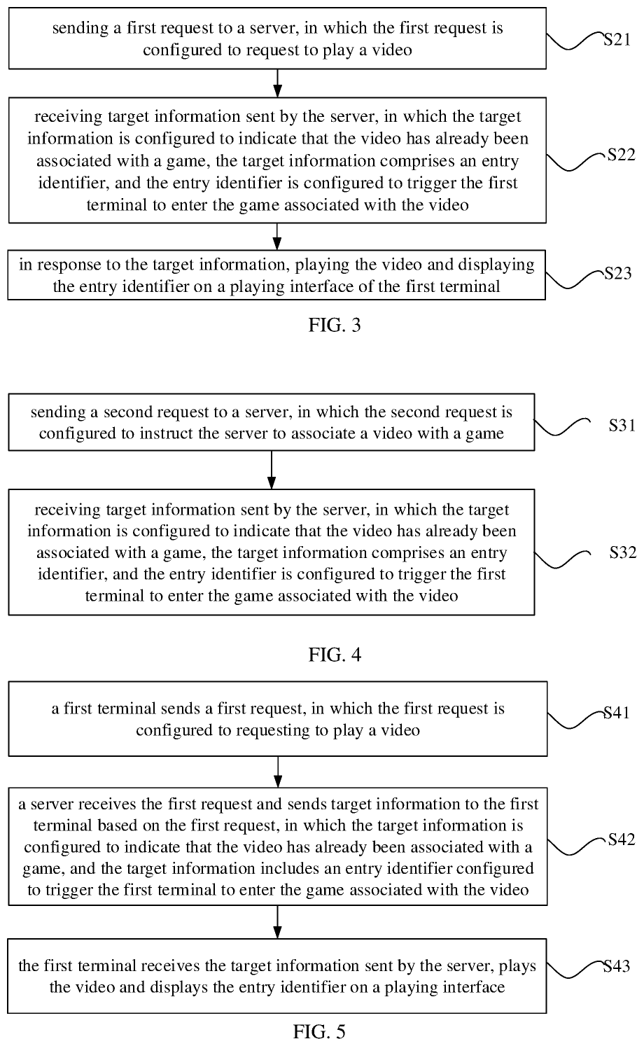

FIG. 3 is a flowchart illustrating a method for processing a video according to another exemplary embodiment. As shown in FIG. 3, the method for processing a video in the embodiment can be used in the first terminal, which includes the following steps S21˜S23.

At S21, a first request is sent to a server. The first request is configured to request play a video.

At S22, target information is received from the server. The target information is configured to indicate that the video has already been associated with a game. The target information includes an entry identifier configured to trigger the first terminal to enter the game associated with the video.

At S23, in response to the target information, the video is played and an entry identifier is displayed on a playing interface of the first terminal.

With the method for processing a video of the disclosure, the first request for requesting to play a video is sent to the server, the target information sent by the server is then obtained; in response to the target information, the entry identifier for triggering the first terminal into the game is displayed on the playing interface. The target information is configured to indicate that the video has already been associated with a game. In the above method, the video is played and the entry identifier is displayed synchronously on the playing interface, and the entry identifier can trigger entry into the game. Therefore, this method may ensure a good carrying capacity of video content and may realize entering the game interface from the video playing interface, which thus better solves the problem that the game cannot be entered from the short video in the related art.

In some embodiments, the first terminal is a video playing terminal.

In order to further facilitate the user to enter the game from the display interface of playing the video, in some embodiments of the disclosure, the method further includes entering the game based on an address of the game in response to an operation on the entry identifier.

In some embodiments, the above operation can be an operation such as clicking, sliding, double clicking, long pressing, etc., and it can also be a combination of other suitable operations.

According to some embodiments of the disclosure, displaying the entry identifier on the playing interface includes: displaying the entry identifier on the playing interface in response to playing the video for a time period. This further ensures a good carrying capacity of video content, and further realizes entering the game interface from the video playing interface.

In some embodiments of the disclosure, the target information is generated by the server in response to a second request. The second request is configured to request to associate the video with the game. In this way, the users may be caused to determine the game associated with the video according to the actual situation, which ensures that the method can be more flexible to meet the needs of different users.

According to some embodiments of the disclosure, the second request is generated in response to a selection operation on the game information, the game information is sent by the server to the second terminal in response to the third request, in which the third request is configured to request a game association function for the video. The game association function is a function associated with the game. The game information includes relevant information of at least one game. The relevant information includes a game address, a game name and a brief game introduction. The at least one of the game includes the game. The game information is displayed on a display interface of the second terminal. In this way, it is ensured that the users can intuitively view the game information, facilitate the users to browse the game information and determine the game associated with the video according to their needs, which further ensures that the method can be more flexible to meet the needs of different users.

In some embodiments, the game information can also be directly sent by the server to the second terminal without responding to the third request.

In some embodiments, the second terminal is a video production terminal, i.e., a client terminal producing a video.

In some embodiments, the second terminal is the same as the first terminal.

In order to further facilitate browsing and selecting the game information by the users, in some embodiments, the game information is displayed in a form of a list on the display interface of the second terminal.

In some embodiments of the disclosure, the game information is generated by the game platform in response to a fourth request sent by the server, and the fourth request is generated by the server based on the third request and is sent to the game platform. The fourth request is configured to request to associate the video with the game platform. In this way, it is ensured that the game information associated with the video can be obtained more simply and quickly.

According to some embodiments of the disclosure, the game information also includes at least one selection identifier corresponding to at least one game one by one. That is, the selection identifiers correspond to multiple pieces of relevant information of the game one by one in position. For example, when multiple pieces of relevant information are arranged in rows, the selection identifier may be in the same line as the corresponding piece of relevant information, and the selection identifier may be in front of or behind the corresponding piece of relevant information; when multiple pieces of relevant information are arranged in columns, the selection identifiers may be in the same column as the corresponding piece of relevant information, and the selection identifier can be located above or below the corresponding piece of relevant information. The position relationship between the selection identifier and the corresponding piece of relevant information can also be other position relationship. The second request is generated in response to the selection operation on the selection identifier that is a selection identifier corresponding to the game. In this way, the user can intuitively know to select the above selection identifier, so that the game corresponding to the selection identifier is then selected, which further facilitates operations of the user.

In some embodiments, the above selection operation can be an operation such as clicking, sliding, double clicking, long pressing, etc., and it can also be a combination of other suitable operations.

The game information may not include a selection identifier. In this case, the users can select a game associated with the video through an operation on relevant information of the game. The operation may include one or more operations of clicking, sliding, double clicking and long pressing. The operation can also include other appropriate operation or a combination of operations.

In some embodiments, third request is generated in response to a second operation on a setting page of the second terminal. In this way, operations of the user are further facilitated, so that the third request can be generated and sent more conveniently and quickly.

In order to further facilitate operations of the user, the setting page includes a start game identifier, and the third request is generated in response to the second operation on the start game identifier. In this way, the user can intuitively know that the game can be started through the second operation on the start game identifier, which is further convenient for the user to operate.

In some embodiments, the second operation can be an operation such as clicking, sliding, double clicking, long pressing, etc., and it can also be other suitable operation or a combination of operations.

In some embodiments, the relevant information can also include other information of the game. According to some embodiments of the disclosure, the target information also includes a game ID, a game cover and a user who is playing the game. Through the game ID, the game cover and the user who is playing the above game in the target information, it is further ensured that the user can have a more intuitive understanding of the game.

According to some embodiments of the disclosure, the target information also includes information of the video, and the information of the video includes at least one of an author account of the video, an author name of the video and a subject of the video. The information of the video can also include other information of the video, which can be set by those skilled in the art according to actual needs.

In some embodiments, after entering the game, the method may include generating a fifth request in response to a third operation on the first terminal, in which the fifth request is configured to request to start the game, and sending the fifth request to the server; receiving information of agreeing to start and displaying a start interface of the game, in which the information of agreeing to start is generated by the game platform in response to the fifth request.

After entering the game, the method may also directly display the start interface of the game.

FIG. 4 is a flowchart illustrating a method for processing a video according to yet another exemplary embodiment. As shown in FIG. 4, the method for processing a video can be used in a second terminal, which includes the following steps S31˜S32.

At S31, a second request is sent to a server. The second request is configured to instruct the server to associate a video with a game

At S32, target information is received from the server. The target information is configured to indicate that the video has already been associated with a game. The target information includes an entry identifier configured to trigger the first terminal to enter the game associated with the video.

With the method for processing a video of the disclosure, a second request for instructing the server to associate the video with the game is sent to the server; the target information is finally received from the server, in which the target information includes the entry identifier for entering the game, and the entry identifier is configured to trigger entering the game via the video. In the above method, the target information is obtained by sending the second request to the server, so that during playing the video on the display interface, the entry identifier can be displayed synchronously, in which the entry identifier can trigger entering the game associated with the video. Therefore, this method may ensure a good carrying capacity of video content and may realize entering the game interface from the video playing interface, which thus better solves the problem that the game cannot be entered from the short video in the related art. Moreover, by sending the second request indicating that the video is associated with the game to the server, the users may be caused to determine the game associated with the video according to the actual situation, which ensures that the method can be more flexible to meet the needs of different users.

In some embodiments, the second terminal is a video production terminal, i.e., a client terminal producing a video. The second terminal may also play a video.

In some embodiments, the video can be obtained in different ways. In some embodiments, the video includes: a video locally cached; or a video during the execution of the game.

According to some embodiments of the disclosure, sending the second request to the server includes: sending a third request to the server, in which the third request is configured to request to start/open a game association function for the video; receiving game information sent by the server and displaying the game information on a display interface, in which the game information includes relevant information of at least one game, the relevant information includes a game address, a game name and a brief game introduction, the at least one game includes the game; receiving a selection operation on the game information; and generating the second request in response to the selection operation and sending the second request to the server. By receiving the game information sent by the server and displaying the game information on the display interface, the method ensures that the user can intuitively view the game information, facilitates the user to browse the game information and determine the game associated with the video according to their needs, which further ensures that the method can be flexible to meet the needs of different users.

In some embodiments, sending the third request can also be omitted in the above method, i.e., the game information is directly sent by the server to the second terminal before sending the second request to the server.

According to some embodiments of the disclosure, the game information is generated by the game platform in response to a fourth request sent by the server, the fourth request is generated by the server based on the third request in which the third request is configured to request to associate the video with the game platform. In this way, it is ensured that the game information associated with the video can be obtained more simply and quickly.

In some embodiments of the disclosure, the game information also includes at least one selection identifier corresponding to at least one game one by one. That is, the selection identifiers correspond to multiple pieces of relevant information of the game one by one in position. For example, when multiple pieces of relevant information are arranged in rows, the selection identifier may be in the same line as the corresponding piece of relevant information, and the selection identifier may be in front of or behind the corresponding piece of relevant information; when multiple pieces of relevant information are arranged in columns, the selection identifiers may be in the same column as the corresponding piece of relevant information, and the selection identifier can be located above or below the corresponding piece of relevant information. The position relationship between the selection identifier and the corresponding piece of relevant information can also be other position relationship. Generating the second request by the second terminal in response to a selection operation on the game information includes: generating the second request by the second terminal in response to the selection operation on the selection identifier, in which the selection identifier is a selection identifier corresponding to the game. In this way, the user can intuitively know to select the above selection identifier, so that the game corresponding to the selection identifier is then selected, which further facilitates operations of the user.

In some embodiments, the above selection operation can be an operation such as clicking, sliding, double clicking, long pressing, etc., and it can also be a combination of other suitable operations.

The game information may not include a selection identifier. In this case, the users can select a game associated with the video through a operation on relevant information of the game. The operation may include one or more operations of clicking, sliding, double clicking and long pressing. The operation can also include other appropriate operation or a combination of operations.

In order to further ensure that the user can determine the game associated with the video according to the actual situation, which further ensures that the method can be more flexible to meet the needs of different users, in some embodiments, the target information is generated by the server in response to the second request.

In some embodiments of the disclosure, after receiving the target information, the method further includes: sending a first request to the server in which the first request is configured to request to play the video; playing the video, and displaying the entry identifier on a display interface of the second terminal. By playing the video on the display interface, the entry identifier that can trigger entering the game is synchronously displayed, which further realizes entering the game interface from the video playing interface and further solves the problem that the game cannot be entered from the short video in the related art.

In some embodiments, the method further includes entering the game based on an address of the game in response to an operation on the entry identifier.

In some embodiments, the operation may include one or more operations of clicking, sliding, double clicking and long pressing. The operation can also include other appropriate operation or a combination of operations.

In some embodiments, the target information also includes a game ID, a game cover and a user who is playing the game. Through the game ID, the game cover and the user who is playing the above game in the target information, it is further ensured that the user can have a more intuitive understanding of the game.

According to some embodiments of the disclosure, the target information also includes video information, and the video information includes at least one of an author account of the video, an author name of the video and a subject of the video. The video information can also include other video information, which can be set by those skilled in the art according to actual needs.

FIG. 5 is a flowchart illustrating a method for processing a video according to yet another exemplary embodiment. As shown in FIG. 5, the method for processing a video includes the following steps S41˜S43.

At S41, a first terminal sends a first request, in which the first request is configured to requesting to play a video.

At S42, a server receives the first request and sends target information to the first terminal based on the first request, in which the target information is configured to indicate that the video has already been associated with a game, and the target information includes an entry identifier configured to trigger the first terminal to enter the game associated with the video.

At S43, the first terminal receives the target information sent by the server, plays the video and displays the entry identifier on a playing interface of the first terminal.

With the method for processing a video of the disclosure, the first terminal first sends the first request for requesting to play the video; the server then receives the first request and sends the corresponding target information to the first terminal based on the first request. The target information includes the entry identifier configured to trigger the first terminal to enter the game associated with the video. Finally, the first terminal receives the target information sent by the server, and controls the playing interface to play the video and display the entry identifier. In the above method, during playing the video on the display interface of the first terminal, the entry identifier can be displayed synchronously, so that the entry identifier can trigger the first terminal to enter the game. Therefore, this method ensures a good carrying capacity of video content and can realize entering the game interface from the video playing interface, which thus better solves the problem that the game cannot be entered from the short video in the related art.

In some embodiments, the first terminal is a video playing terminal.

In some embodiments, the video is a short video. The video can also be other video in the related art.

In some embodiments of the disclosure, before the first terminal sends the first request, the method also includes: generating the target information by the server. This facilitates the server to send the corresponding target information to the first terminal based on the first request.

According to some embodiments of the disclosure, generating the target information by the server includes: sending by a second terminal, a second request, in which the second request is configured to request to associate the video with the game to the server; and receiving by the server, the second request and generating the target information in response to the second request. In this way, the user may be caused to determine the game associated with the video according to the actual situation, which ensures that the method can be more flexible to meet the needs of different users.

In some embodiments, the second terminal is a video production terminal. The first terminal can be the same as the second terminal. The first terminal can also be different from the second terminal.

According to some embodiments of the disclosure, sending by the second terminal, the second request to the server includes: sending by the second terminal, a third request, in which the third request is configured to request to start a game association function for the video; receiving by the server, the third request and sending the game information to the second terminal based on the third request, in which the game information includes relevant information of at least one game, the relevant information includes a game address, a game name and a brief game introduction, the at least one game includes the game; displaying by the second terminal, the game information; and generating by the second terminal, the second request in response to a selection operation on the game information. In this way, it is ensured that the users can intuitively view the game information, facilitate the users to browse the game information and determine the game associated with the video according to their needs, which further ensures that the method can be more flexible to meet the needs of different users.

In some embodiments, the second terminal sending the third request can also be omitted in the above method, i.e., the server directly sends the game information to the second terminal before the second terminal sends the second request to the server.

According to some embodiments of the disclosure, receiving by the server, the third request and sending the game information to the second terminal based on the third request includes: generating by the server, a fourth request based on the third request, in which the first request is configured to request to associate the video with a game platform, and sending the fourth request to the game platform; receiving by the game platform, the fourth request, generating the game information based on the fourth request, and sending the game information to the server; and receiving by the server, the game information and forwards the game information to the second terminal. In this way, it is ensured that the game information associated with the video can be obtained more simply and quickly.

In order to further facilitate browsing and selecting the game information by the users, in some embodiments, the game information is displayed in a form of a list on the display interface of the second terminal.

In some embodiments of the disclosure, the game information also includes at least one selection identifier corresponding to at least one game one by one. That is, the selection identifiers correspond to multiple pieces of relevant information of the game one by one in position. For example, when multiple pieces of relevant information are arranged in rows, the selection identifier may be in the same line as the corresponding piece of relevant information, and the selection identifier may be in front of or behind the corresponding piece of relevant information; when multiple pieces of relevant information are arranged in columns, the selection identifiers may be in the same column as the corresponding piece of relevant information, and the selection identifier can be located above or below the corresponding piece of relevant information. The position relationship between the selection identifier and the corresponding piece of relevant information can also be other position relationship. Generating the second request by the second terminal in response to a selection operation on the game information includes: generating the second request by the second terminal in response to the selection operation on the selection identifier, in which the selection identifier is a selection identifier corresponding to the game. In this way, the user can intuitively know to select the above selection identifier, so that the game corresponding to the selection identifier is then selected, which further facilitates operations of the user.

In some embodiments, the above selection operation can be an operation such as clicking, sliding, double clicking, long pressing, etc., and it can also be a combination of other suitable operations.

The game information may not include a selection identifier. In this case, the users can select a game associated with the video through an operation on relevant information of the game. The operation may include one or more operations of clicking, sliding, double clicking and long pressing. The operation can also include other appropriate operation or a combination of operations.

In some embodiments of the disclosure, sending by the second terminal a third request for requesting start a game association function for the video includes: displaying a setting page by the second terminal; and generating the third request in response to a second operation on the setting page. In this way, operations of the user are further facilitated, so that the third request can be generated and sent more conveniently and quickly.

In order to further facilitate operations of the user, according to some embodiments of the disclosure, the setting page includes a start game identifier, and generating the third request in response to the second operation on the setting page includes: generating the third request in response to the second operation on the start game identifier. In this way, the user can intuitively know that the game can be started through the second operation on the start game identifier, which is further convenient for the user to operate.

In some embodiments, the second operation can be an operation such as clicking, sliding, double clicking, long pressing, etc., and it can also be other suitable operation or a combination of operations.

In some embodiments, the target information also includes a game ID, a game cover and a user who is playing the game. Through the game ID, the game cover and the user who is playing the above game in the target information, it is further ensured that the user can have a more intuitive understanding of the game.

In some embodiments of the disclosure, the video information includes at least one of an author account of the video, an author name of the video and a subject of the video. The video information can also include other video information, which can be set by those skilled in the art according to actual needs.

In some embodiments, the second terminal is the same as the first terminal. That is, the terminal can perform both video playback and video production.

In some embodiments, after entering the game in response to the second operation on the start game identifier, the method may include generating a fifth request in response to a third operation on the first terminal, in which the fifth request is configured to request to start the game. The game platform receives the fifth request and sends the information of agreeing to start to the first terminal. Based on the information of agreeing to start, the first terminal displays a start interface of the game.

After entering the game in response to the second operation on the start game identifier, the method may also directly display the start interface of the game.

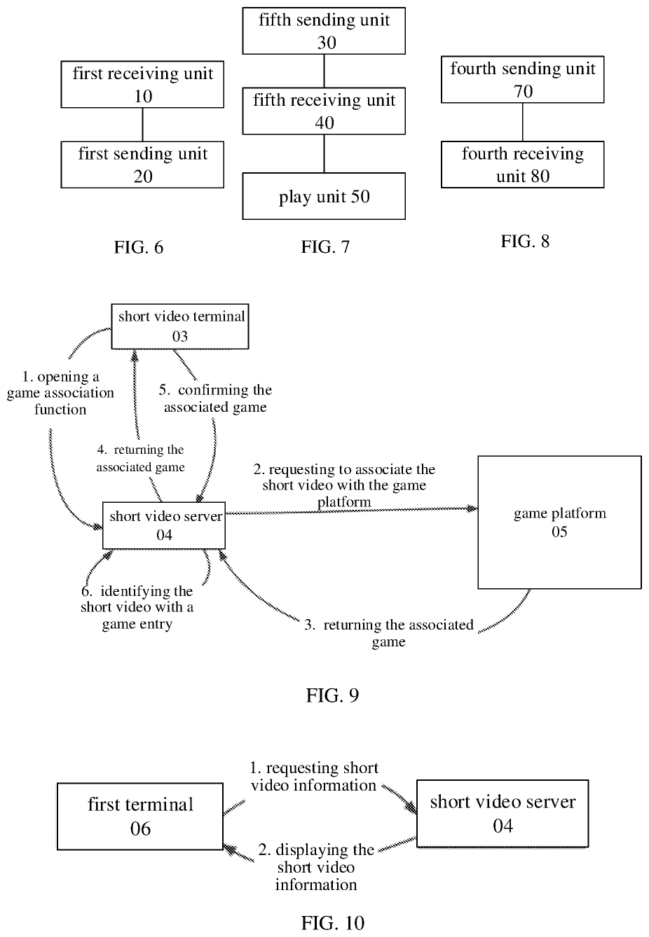

FIG. 6 is a block diagram illustrating an apparatus for processing a video according to some embodiments. Referring to FIG. 6, the apparatus includes a first receiving unit 10 and a first sending unit 20.

The first receiving unit 10 is configured to perform receiving a first request sent by a first terminal, in which the first request is configured to request to play a video.

The first sending unit 20 is configured to perform sending target information to the first terminal based on the first request. The target information is configured to indicate that the video has already been associated with a game. The target information includes an entry identifier configured to trigger the first terminal to enter the game associated with the video.

The apparatus for processing a video of the disclosure receives the first request for requesting to play the video sent by the first terminal via the first receiving unit; the first sending unit sends the target information based on the first request. In the above apparatus, the target information with the entry identifier is sent to the first terminal based on the first request for requesting to play the video sent by the first terminal, so that the entry identifier can be displayed synchronously during playing the video on the display interface of the first terminal, in which the entry identifier can trigger the first terminal to enter the game. Therefore, the apparatus may ensure a good carrying capacity of video content and may realize entering the game interface from the video playing interface, which thus better solves the problem that the game cannot be entered from the short video in the related art.

In some embodiments, the first terminal is a video playing terminal.

In some embodiments, the video is a short video. Alternatively, the video can also be other videos in the related art.

According to some embodiments of the disclosure, the apparatus also includes an establishment unit for establishing an association between the video and the game and generating the target information before sending the target information to the first terminal based on the first request. By establishing the association between the video and the game and generating the target information, the apparatus can easily and quickly determine the game associated with the video.

According to some embodiments of the disclosure, the establishment unit includes a first receiving module and a first response module. The first receiving module is configured to receive a second request sent by the second terminal for requesting to associate the video with the game. The first response module is configured to in response to the second request, establish the association between the video and the game and generate the target information. In response to receiving the second request for requesting to associate the video with the game, the apparatus establishes the association between the video and the game and generates the target information, so that the user can determine the game associated with the video according to the actual situation, which ensures that the apparatus can be more flexible to meet the needs of different users.

In some embodiments, the second terminal is the video production terminal, that is, the user terminal producing the video.

In some embodiments, the second terminal is the same as the first terminal.

According to some embodiments of the disclosure, the apparatus includes a second receiving unit and a second sending unit. The second receiving unit is configured to receive a third request sent by the second terminal before receiving second request sent by the second terminal. The third request is configured to request start a game association function for the video. The game association function is a function associated with the game. The second sending unit is configured to send game information to the second terminal, and display the game information on a display interface of the second terminal. The game information includes relevant information of at least one game. The relevant information includes a game address, a game name and a brief game introduction. The at least one game includes the game. The second request is generated in response to a selection operation on the game information. In this way, it is ensured that the users can intuitively view the game information, facilitate the users to browse the game information and determine the game associated with the video according to their needs, which further ensures that the method can be more flexible to meet the needs of different users.

In some embodiments, the apparatus can also omit receiving the third request. Before receiving the second request sent by the second terminal, the apparatus directly sends the game information to the second terminal.

In order to further facilitate browsing and selecting the game information by the users, in some embodiments, the game information is displayed in a form of a list on the display interface of the second terminal.

In some embodiments of the disclosure, the apparatus further includes a third sending unit and a third receiving unit. The third sending unit is configured to after the third request sent by the second terminal is received and before the game information is sent to the second terminal, send a fourth request to a game platform based on the third request. The fourth request is configured to request to associate the video with the game platform. The third receiving unit is configured to receive the game information sent by the game platform. In this way, it is ensured that the game information associated with the video can be obtained more simply and quickly.

According to some embodiments of the disclosure, the game information also includes at least one selection identifier corresponding to at least one game one by one. That is, the selection identifiers correspond to multiple pieces of relevant information of the game one by one in position. For example, when multiple pieces of relevant information are arranged in rows, the selection identifier may be in the same line as the corresponding piece of relevant information, and the selection identifier may be in front of or behind the corresponding piece of relevant information; when multiple pieces of relevant information are arranged in columns, the selection identifiers may be in the same column as the corresponding piece of relevant information, and the selection identifier can be located above or below the corresponding piece of relevant information. The position relationship between the selection identifier and the corresponding piece of relevant information can also be other position relationship. The second request is generated in response to the selection operation on the selection identifier that is a selection identifier corresponding to the game. In this way, the user can intuitively know to select the above selection identifier, so that the above game corresponding to the above selection identifier is then selected, which further facilitates operations of the user.

In some embodiments, the above selection operation can be an operation such as clicking, sliding, double clicking, long pressing, etc., and it can also be a combination of other suitable operations.

The game information may not include a selection identifier. In this case, the users can select a game associated with the video through a operation on relevant information of the game. The operation may include one or more operations of clicking, sliding, double clicking and long pressing. The operation can also include other appropriate operation or a combination of operations.

In some embodiments, a third request is generated in response to a second operation on a setting page of the second terminal. In this way, operations of the user are further facilitated, so that the third request can be generated and sent more conveniently and quickly.

In order to further facilitate operations of the user, in some embodiments of the disclosure, the setting page includes a start game identifier, and the third request is generated in response to the second operation on the start game identifier. In this way, the user can intuitively know that the game can be started through the second operation on the start game identifier, which is further convenient for the user to operate.

In some embodiments, the second operation can be an operation such as clicking, sliding, double clicking, long pressing, etc., and it can also be other suitable operation or a combination of operations.

In some embodiments, the target information also includes a game ID, a game cover and a user who is playing the game. Through the game ID, the game cover and the user who is playing the above game in the target information, it is further ensured that the user can have a more intuitive understanding of the game.

According to some embodiments of the disclosure, the target information also includes information of the video, and the information of the video includes at least one of an author account of the video, an author name of the video and a subject of the video. The information of the video can also include other information of the video, which can be set by those skilled in the art according to actual needs.

In some embodiments, after entering the game in response to the second operation on the start game identifier, the method may include generating a fifth request in response to a third operation on the first terminal, in which the fifth request is configured to request to start the game. The game platform receives the fifth request and sends information of agreeing to start to the first terminal. Based on the information of agreeing to start, the first terminal displays a start interface of the game.

After entering the game in response to the second operation on the start game identifier, the apparatus may also directly display the start interface of the game.

As for the apparatus in the above embodiments, the specific implementations in which each module performs operations has been described in detail in the related method embodiment, which will not be described in detail here.

FIG. 7 is a block diagram illustrating an apparatus for processing a video according to another exemplary embodiment. Referring to FIG. 7, the apparatus includes a fifth sending unit 30, a fifth receiving unit 40, and a play unit 50. The second sending unit is configured to send a first request to a server, in which the first request is configured to request to play a video. The second receiving unit is configured to receive target information sent by the server, in which the target information is configured to indicate that the video has already been associated with a game, the target information includes an entry identifier, and the entry identifier is configured to trigger the first terminal to enter the game associated with the video. The play unit is configured to in response to the target information, play the video and display the entry identifier on a playing interface of the first terminal.

The apparatus for processing a video of the disclosure sends the first request via the fifth sending unit, receives the target information via the fifth receiving unit, and plays the video and displays the entry identifier on a playing interface of the first terminal in response to the target information via the play unit. In the above apparatus, the entry identifier is displayed synchronously during playing the video on the display interface, and the entry identifier can trigger entry into the game. Therefore, the apparatus may ensure a good carrying capacity of video content and may realize entering the game interface from the video playing interface, which thus better solves the problem that the game cannot be entered from the short video in the related art.

In some embodiments, the first terminal is a video playing terminal.

In order to further facilitate the user to enter the game from the display interface of playing the video, according to some embodiments of the disclosure, the apparatus also includes a first entering unit, configured to enter the game based on an address of the game in response to an operation on the entry identifier.

In some embodiments, the above operation can be an operation such as clicking, sliding, double clicking, long pressing, etc., and it can also be a combination of other suitable operations.

According to some embodiments of the disclosure, the display unit includes a display module, configured to display the entry identifier on the playing interface after playing the video for a time. This further ensures the better carrying capacity of video content, and further realizes entering the game interface from the video playing interface.

In some embodiments of the disclosure, the first obtaining unit includes a second receiving module. The second receiving module is configured to receive the target information sent by a server, in which the target information is generated by the server in response to a second request for requesting to associate the video with the game. In this way, the user may be caused to determine the game associated with the video according to the actual situation, which ensures that the method can be more flexible to meet the needs of different users.

According to some embodiments of the disclosure, the second request is generated in response to a selection operation on the game information, the game information is sent by the server to the second terminal in response to the third request for requesting the video to start a game association function. The game association function is a function associated with the game. The game information includes relevant information of at least one game. The relevant information includes a game address, a game name and a brief game introduction. The at least one of the game includes the game. The game information is displayed on a display interface of the second terminal. In this way, it is ensured that the users can intuitively view the game information, facilitate the users to browse the game information and determine the game associated with the video according to their needs, which further ensures that the method can be more flexible to meet the needs of different users.

In some embodiments, the game information can also be directly sent by the server to the second terminal without responding to the third request.

In some embodiments, the second terminal is a video production terminal, i.e., a client terminal producing a video.

In some embodiments, the second terminal is the same as the first terminal.

In order to further facilitate browsing and selecting the game information by the users, in some embodiments, the game information is displayed in a form of a list on the display interface of the second terminal.

In some embodiments of the disclosure, the game information is generated by the game platform in response to a fourth request sent by the server, and the fourth request is generated by the server based on the third request and is sent to the game platform. The fourth request is configured to request to associate the video with the game platform. In this way, it is ensured that the game information associated with the video can be obtained more simply and quickly.

According to some embodiments of the disclosure, the game information also includes at least one selection identifier corresponding to at least one game one by one. That is, the selection identifiers correspond to multiple pieces of relevant information of the game one by one in position. For example, when multiple pieces of relevant information are arranged in rows, the selection identifier may be in the same line as the corresponding piece of relevant information, and the selection identifier may be in front of or behind the corresponding piece of relevant information; when multiple pieces of relevant information are arranged in columns, the selection identifiers may be in the same column as the corresponding piece of relevant information, and the selection identifier can be located above or below the corresponding piece of relevant information. The position relationship between the selection identifier and the corresponding piece of relevant information can also be other position relationship. The second request is generated in response to the selection operation on the selection identifier that is a selection identifier corresponding to the game. In this way, the user can intuitively know to select the above selection identifier, so that the game corresponding to the selection identifier is then selected, which further facilitates operations of the user.

In some embodiments, the above selection operation can be an operation such as clicking, sliding, double clicking, long pressing, etc., and it can also be a combination of other suitable operations.

The game information may not include a selection identifier. In this case, the users can select a game associated with the video through a operation on relevant information of the game. The operation may include one or more operations of clicking, sliding, double clicking and long pressing. The operation can also include other appropriate operation or a combination of operations.

In some embodiments, a third request is generated in response to a second operation on a setting page of the second terminal. In this way, operations of the user are further facilitated, so that the third request can be generated and sent more conveniently and quickly.

In order to further facilitate operations of the user, the setting page includes a start game identifier, and the third request is generated in response to the second operation on the start game identifier. In this way, the user can intuitively know that the game can be started through the second operation on the start game identifier, which is further convenient for the user to operate.

In some embodiments, the second operation can be an operation such as clicking, sliding, double clicking, long pressing, etc., and it can also be other suitable operation or a combination of operations.

In some embodiments, the relevant information can also include other information of the game. According to some embodiments of the disclosure, the target information also includes a game ID, a game cover and a user who is playing the game. Through the game ID, the game cover and the user who is playing the above game in the target information, it is further ensured that the user can have a more intuitive understanding of the game.

According to some embodiments of the disclosure, the target information also includes information of the video, and the information of the video includes at least one of an author account of the video, an author name of the video and a subject of the video. The information of the video can also include other information of the video, which can be set by those skilled in the art according to actual needs.

In some embodiments, after entering the game, the apparatus may generate a fifth request in response to a third operation on the first terminal, in which the fifth request is configured to request to start the game; receive the information of agreeing to start and display a start interface of the game, in which the information of agreeing to start is generated by the game platform in response to the fifth request.

After entering the game, the method may also directly display the start interface of the game.

FIG. 8 is a block diagram illustrating an apparatus for processing a video according to another exemplary embodiment. Referring to FIG. 8, the apparatus includes a fourth sending unit 70, and a fourth receiving unit 80.

The fourth sending unit 70 is configured to send a second request to a server, in which the second request is configured to instruct the server to associate a video with a game.

The fourth receiving unit 80 is configured to perform receiving target information sent by the server. The target information is configured to indicate that the video has already been associated with a game. The target information includes an entry identifier configured to trigger the first terminal to enter the game associated with the video.

The apparatus for processing a video of the disclosure sends a second request to the server via the fourth sending unit, in which the second request is configured to instruct a server to associate the video with the game, receives the target information via the fourth receiving unit, in which the target information includes the entry identifier for entering the game, and the entry identifier is configured to trigger entering the game via the video. In the above apparatus, the target information is obtained by sending the second request to the server, so that during playing the video on the display interface, the entry identifier can be displayed synchronously, in which the entry identifier can trigger entering the game associated with the video. Therefore, the apparatus may ensure a good carrying capacity of video content and may realize entering the game interface from the video playing interface, which thus better solves the problem that the game cannot be entered from the short video in the related art. Moreover, by sending the second request indicating that the video is associated with the game to the server, the user may be caused to determine the game associated with the video according to the actual situation, which ensures that the apparatus can be more flexible to meet the needs of different users.

In some embodiments, the second terminal is a video production terminal, i.e., a client terminal producing a video. The second terminal may also play a video.

In some embodiments, the video can be obtained through different ways. In some embodiments, the second obtaining unit includes a first obtaining module configured to obtain a video locally cached; or configured to obtain the video by obtaining a video during the execution of the game.

According to some embodiments of the disclosure, the fourth sending unit includes a sending module, a third receiving module and a generating module. The sending module is configured to send a third request to a server. The third request is configured to request a game association function for the video. The third receiving module is configured to receive game information sent by the server and display the game information on a display interface, and receive a selection operation on the game information. The game information includes relevant information of at least one game. The relevant information includes a game address, a game name and a brief game introduction. The at least one game includes the game. The generation module is configured to generate the second request in response to the selection operation and send the second request to the server. By receiving the game information sent by the server and displaying the game information on the display interface, the apparatus ensures that the user can intuitively view the game information, facilitates the user to browse the game information and determine the game associated with the video according to their needs, which further ensures that the apparatus can be flexible to meet the needs of different users.

In some embodiments, the above apparatus can also omit sending the third request, i.e., the server directly sends the game information to the second terminal before sending the second request to the server.

According to some embodiments of the disclosure, the game information is generated by the game platform in response to the fourth request sent by the server. The fourth request is configured to request to associate the video with the game platform, and is generated by the server based on the third request. In this way, it is ensured that the game information associated with the video can be obtained more simply and quickly.

In some embodiments of the disclosure, the game information also includes at least one selection identifier corresponding to at least one game one by one. That is, the selection identifiers correspond to multiple pieces of relevant information of the game one by one in position. For example, when multiple pieces of relevant information are arranged in rows, the selection identifier may be in the same line as the corresponding piece of relevant information, and the selection identifier may be in front of or behind the corresponding piece of relevant information; when multiple pieces of relevant information are arranged in columns, the selection identifiers may be in the same column as the corresponding piece of relevant information, and the selection identifier can be located above or below the corresponding piece of relevant information. The position relationship between the selection identifier and the corresponding piece of relevant information can also be other position relationship. Generating the second request by the second terminal in response to a selection operation on the game information includes: generating the second request by the second terminal in response to the selection operation on the selection identifier, in which the selection identifier is a selection identifier corresponding to the game. In this way, the user can intuitively know to select the above selection identifier, so that the game corresponding to the selection identifier is then selected, which further facilitates operations of the user.

In some embodiments, the above selection operation can be an operation such as clicking, sliding, double clicking, long pressing, etc., and it can also be a combination of other suitable operations.

The game information may not include a selection identifier. In this case, the users can select a game associated with the video through a operation on relevant information of the game. The operation may include one or more operations of clicking, sliding, double clicking and long pressing. The operation can also include other appropriate operation or a combination of operations.

In order to further ensure that the user can determine the game associated with the video according to the actual situation, which further ensures that the apparatus can be more flexible to meet the needs of different users, in some embodiments, the target information is generated by the server in response to the second request.

In some embodiments of the disclosure, the apparatus also includes a fifth sending unit and a playing unit. The fifth sending unit is configured to send a first request to the server after receiving the target information. The first request is configured to request to play the video. The playing unit is configured to play the video and display the entry identifier on a display interface. By playing the video on the display interface, the entry identifier that can trigger entering the game is synchronously displayed, which further realizes entering the game interface from the video playing interface and further solves the problem that the game cannot be entered from the short video in the related art.

In some embodiments, the apparatus also includes a second entering unit configured to enter the game based on an address of the game in response to a operation on the entry identifier.

In some embodiments, the operation may include one or more operations of clicking, sliding, double clicking and long pressing. The operation can also include other appropriate operation or a combination of operations.

In some embodiments, the target information also includes a game ID, a game cover and a user who is playing the game. Through the game ID, the game cover and the user who is playing the above game in the target information, it is further ensured that the user can have a more intuitive understanding of the game.

According to some embodiments of the disclosure, the target information also includes video information . The video information includes at least one of an author account of the video, an author name of the video and a subject of the video. The video information can also include other video information, which can be set by those skilled in the art according to actual needs.

In some embodiments, an electronic device is also provided, which includes a processor and a memory for storing instructions executable by the processor. The processor is configured to execute the instructions to implement any of the above methods.

In some embodiments, a system is also provided. The system includes a server and a first terminal. The server is configured to perform any of the above methods used in the server. The first terminal is communicatively connected with the server for executing the methods used in the first terminal.

In the above system, during playing the video on the display interface of the first terminal, the entry identifier can be displayed synchronously, so that the entry identifier can trigger the first terminal to enter the game. Therefore, the system ensures a good carrying capacity of video content, which can enter the game interface from the video playing interface, so as to better solve the problem that the game cannot be entered from the short video in the related art.

According to some embodiments of the disclosure, the system also includes a second terminal communicatively connected with the server. The second terminal is configured to send a second request to the server, in which the second request is configured to request to associate the video with a game. That is, the second terminal may request to associate the video with the game.

In some embodiments, the first terminal is a video playing terminal, and the second terminal is a video production terminal.

FIG. 9 to FIG. 11 illustrates system flowcharts work according to an embodiment of the disclosure, respectively. As can be seen from FIG. 9, the short video terminal 03 sends a third request for requesting to start a game association function to the server 04. After receiving the third request, the server 04 generates a fourth request for requesting to associate a target short video with the game platform 05, and sends the fourth request to the game platform 05. The game platform 05 generates game information based on the fourth request, and sends the game information to the server 04. The server 04 receives and forwards the game information to the short video terminal 03. The short video terminal 03 determines a game associated with the target short video based on the game information, generates and sends a second request to the server 04. The server 04 generates target information. During playing the target short video, a entry identifier in the target information can be displayed to trigger the short video terminal 03 to enter the game.

As shown in FIG. 10, the first terminal 06 sends a first request for requesting to play a short video to the server 04. The server 04 receives the first request and sends the corresponding target information to the first terminal 06 based on the first request.

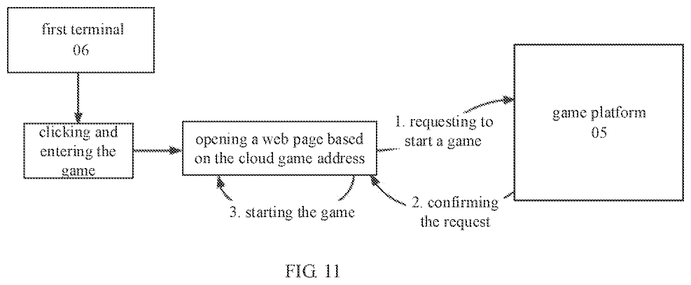

As shown in FIG. 11, the first terminal 06 displays a web page of the game in response to a second operation on a start game identifier, generates a fifth request for requesting to start the game in response to a third operation on the first terminal 06, and sends the fifth request to the game platform 05. The game platform 05 receives the fifth request and sends confirm information to the first terminal 06. The first terminal displays a start interface of the game based on the confirm information. The short video terminal includes a second terminal as a video production terminal and a first terminal as a video playing terminal.

In the exemplary embodiment, a computer-readable storage medium including instructions is also provided. When the instructions in the computer-readable storage medium are executed by a processor of an electronic device, the electronic device is enabled to execute any of the above methods. Alternatively, the computer-readable storage medium may be an ROM, a random access memory (RAM), a CD-ROM, a magnetic tape, a floppy disk, an optical data storage device, etc..

In some embodiments, a computer program product including computer programs/instructions is also provided. When the programs/instructions are executed by a processor, any of the above methods is implemented.

After considering the description and practicing the above disclosure, those skilled in the art will be aware of other embodiments of the disclosure. The disclosure is intended to cover any variations, uses or adaptive changes of the disclosure, which fall within scope of the disclosure defined by the following claims. The description and embodiments are regarded as exemplary only, and the scope of the disclosure is defined by the following claims.

It should be understood that the disclosure is not limited to the precise structure already described above and shown in the drawings, and various modifications and changes may be made without departing from its scope. The scope of the disclosure is limited only by the appended claims.

What is claimed is:

1. A method for processing a video, performed by a server, comprising:
receiving a first request sent by a first terminal, in which the first request is configured to request to play a video; and
sending target information to the first terminal based on the first request, in which the target information is configured to indicate that the video has already been associated with a game, the target information comprises an entry identifier, and the entry identifier is configured to trigger the first terminal to enter the game associated with the video.

2. The method of claim 1, further comprising:
establishing an association between the video and the game and generating the target information.

3. The method of claim 2, wherein establishing the association between the video and the game and generating the target information comprises:
receiving a second request sent by a second terminal, in which the second request is configured to request to associate the video with the game; and
in response to the second request, establishing the association between the video and the game and generating the target information.

4. The method of claim 1, further comprising:
receiving a third request sent by the second terminal, in which the third request is configured to request a game association function for the video; and
sending game information to the second terminal and displaying the game information on a display interface of the second terminal, in which the game information comprises a game address, a game name and a brief game introduction of at least one game, and the second request is generated in response to a selection operation on the game information.

5. The method of claim 4, further comprising:
sending a fourth request to a game platform based on the third request, in which the fourth request is configured to request to associate the video with the game platform; and
receiving the game information sent by the game platform.

6. The method of claim 4, wherein the game information further comprises at least one selection identifier corresponding to the at least one game one by one, and the second request is generated in response to a selection operation on the selection identifier corresponding to the game.

7. The method of claim 1, wherein the target information further comprises a game ID, a game cover and a user who is playing the game.

8. The method of claim 1, wherein the target information further comprises video information, and the video information comprises at least one of an author account, an author name and a subject of the video.

9. The method of claim 1, wherein:
in response to an operation on the entry identifier, the first terminal enters the game based on a game address.

10. The method of claim 9, wherein:
in response to playing the video for a time period, the first terminal displays the entry identifier on the playing interface.

11. A method for processing a video, performed by a second terminal, comprising:
sending a second request to a server, in which the second request is configured to instruct the server to associate a video with a game; and
receiving target information sent by the server, in which the target information is configured to indicate that the video has already been associated with a game, the target information comprises an entry identifier, and the entry identifier is configured to trigger the first terminal to enter the game associated with the video.

12. The method of claim 11, wherein the video comprises at least one of: a video locally cached; and a video during the execution of the game.

13. The method of claim 11, wherein sending the second request to the server comprises:
sending a third request to the server, in which the third request is configured to request a game association function for the video;
receiving game information sent by the server and displaying the game information on a display interface of the second terminal, in which the game information comprises a game address, a game name and a brief game introduction of at least one game;
receiving a selection operation on the game information; and
generating the second request in response to the selection operation and sending the second request to the server.

14. The method of claim 13, wherein the game information is generated by a game platform in response to a fourth request sent by the server, the fourth request is configured to request to associate the video with the game platform and is generated by the server based on the third request.

15. The method of claim 11, wherein the target information is generated by the server in response to the second request.

16. The method of claim 11, further comprising:
sending a first request to the server, in which the first request is configured to request to play the video; and
playing the video, and displaying the entry identifier on a display interface of the second terminal.

17. The method of claim 16, further comprising:
in response to an operation on the entry identifier, entering the game based on an address of the game.

18. An electronic device, comprising:
a processor; and
a memory for storing instructions executable by the processor;
wherein the processor is configured to:
receive a first request sent by a first terminal, in which the first request is configured to request to play a video; and
send target information to the first terminal based on the first request, in which the target information is configured to indicate that the video has already been associated with a game, the target information comprises an entry identifier, and the entry identifier is configured to trigger the first terminal to enter the game associated with the video.

19. The electronic device of claim 18, wherein the processor is further configured to:
establish an association between the video and the game and generating the target information.

20. The electronic device of claim 19, wherein the processor is further configured to:
receive a second request sent by a second terminal, in which the second request is configured to request to associate the video with the game; and
in response to the second request, establish the association between the video and the game and generating the target information.
